(19) United States
(12) Patent Application Publication
(10) Pub. No.: US 2024/0363866 A1
(43) Pub. Date: Oct. 31, 2024

(54) COATING FOR NEGATIVE ELECTRODE AND SOLID-STATE BATTERIES COMPRISING SAME

(71) Applicant: Factorial Inc., Woburn, MA (US)

(72) Inventors: Won Seok Chang, Cambridge, MA (US); Takaaki Miki, Malden, MA (US); Hosang Park, Winchester, MA (US); Jae Myung Lee, Belmont, MA (US); Hyun Seok Kim, Lexington, MA (US)

(21) Appl. No.: 18/641,550

(22) Filed: Apr. 22, 2024

Related U.S. Application Data
(60) Provisional application No. 63/517,364, filed on Aug. 3, 2023.
(60) Provisional application No. 63/498,545, filed on Apr. 27, 2023.

(51) Int. Cl. H01M 4/62; H01M 4/02; H01M 10/0525; H01M 10/0562

(52) U.S. Cl. CPC H01M 4/62; H01M 10/0562; H01M 2004/021; H01M 2004/027; H01M 10/0525; H01M 2300/0068

(57) ABSTRACT

Disclosed is a coating comprising two elements (A and B) and a carbonaceous material, wherein element A is alloyable with lithium and element B is not alloyable with lithium. Methods for preparing the coating and all solid-state battery (ASSB) comprising the same are also disclosed. In one embodiment, ASSB comprising the coating exhibits a reduced charging overpotential and an improved specific capacity and cycle life.

### CROSS-REFERENCE

The present application claims priority of U.S. Ser. No. 63/517,364, filed Aug. 3, 2023 and U.S. Ser. No. 63/498,545, filed Apr. 27, 2023, the entire content of which are incorporated herein by reference into this application.

### FIELD

This disclosure relates to a coating comprising two elements (A and B) and a carbonaceous material, wherein element A is alloyable with lithium and element B is not alloyable with lithium. Solid-state batteries comprising the same are also disclosed.

### BACKGROUND

Lithium metal anodes are promising over other types of anodes (such as graphite-based anodes) for use in high energy-density all-solid-state batteries (ASSBs) due to its theoretical capacity (3,860 mAh/g). However, formation of lithium dendrite may cause safety problems and lead to a short cycle life. It has been shown that a nanocomposite layer of Ag/C on lithium metal anode can lead to an improved cycle life. Silver nanoparticles are prone to forming agglomerations and may deteriorate the safety issue by accelerating the growth of the lithium dendrite. Thus, there remains a need for a new anode design.

### SUMMARY

The present disclosure provides an anode coating (alternatively, layer) comprising two elements (A and B) and a carbonaceous material, wherein element A is alloyable with lithium and element B is not alloyable with lithium. Methods for preparing the anode coating and all solid-state battery (ASSB) comprising the same are also disclosed.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 is a schematic diagram showing a coating (1) comprising particles of element A (2), particles of element B (3), and a carbonaceous material (4) on an anode current collector (5) according to one embodiment of the present disclosure.

FIG. 2 is a schematic diagram showing a coating (1) comprising particles of element A (2), particles of element B (3), and a carbonaceous material (4) on an anode active material layer (6) comprising lithium metal according to one embodiment of the present disclosure. FIG. 3 shows the rate capability of batteries comprising coatings of the reference example (Ref. Ex), comparative example 1 (Comp. Ex 1), comparative example 2 (Comp. Ex 2), comparative example 3 (Comp. Ex 3), example 1 (Ex 1), example 2 (Ex 2), example 3 (Ex 3), example 4 (Ex 4), example 5 (Ex 5), and example 6 (Ex 6) according to some embodiments of the present disclosure.

FIG. 4 shows the discharge capacity cycle performance of batteries comprising coatings of the reference example (Ref. Ex), comparative example 1 (Comp. Ex 1), comparative example 2 (Comp. Ex 2), comparative example 3 (Comp. Ex 3), example 4 (Ex 4) and example 5 (Ex 5) according to some embodiment of the present disclosure.

FIG. 5 shows an SEM image of a coating comprising Ag/C prepared according to the reference example.

FIG. 6 shows an SEM image of a coating comprising Zn as element A, Cu as element B, and a carbonaceous material according to example 4.

FIG. 7 shows the electrochemical impedance spectroscopy (EIS) results of the reference example (Ref. Ex) and example 4 (Ex 4) before and after rate capability test.

FIG. 8 shows high c-rate capability half-cell test of Example 5 vs. Ref. example up to 5.5 C (1 C=170 mAh) according to one embodiment of the present disclosure.

FIG. 9 shows cycle performance half-cell test of Example 5 vs. Ref. example based on 0.33 C (1 C=170 mAh) according to one embodiment of the present disclosure.

### DETAILED DESCRIPTION

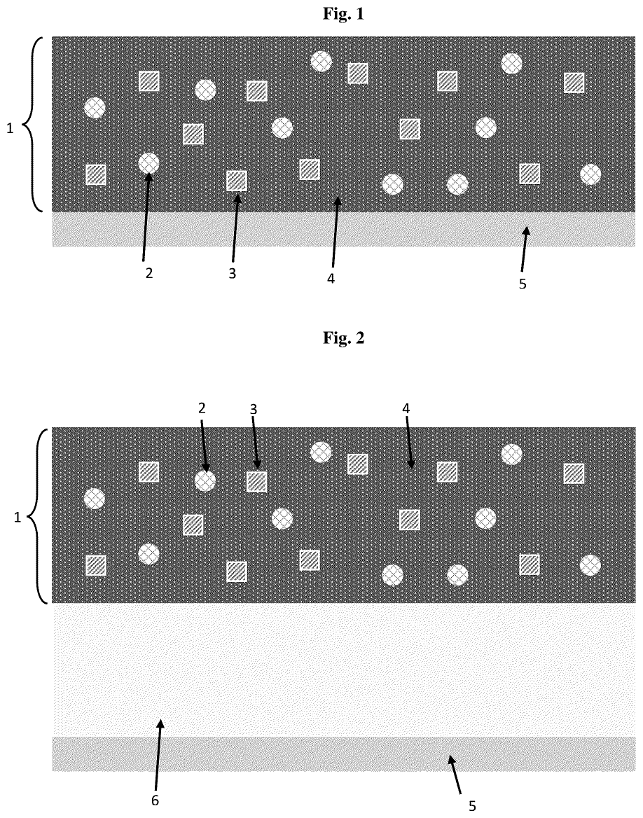

Disclosed herein is a coating that provides desirable cycle life and safety benefits when incorporated into an all-solid state battery. In some embodiments, the coating (or alternatively, a layer) includes at least two metal or metalloid elements (A and B) and a carbonaceous material, wherein element A is alloyable with lithium and element B is not alloyable with lithium. In some embodiments, the coatings disclosed herein are coatings for a negative electrode, such as an anode. In some embodiments, the coatings are interfacial layers between a negative electrode and an electrolyte in an electrochemical device. In some embodiments, the coatings are in direct contact with an anode current collector or an anode active material layer of an anode or negative electrode. As used herein, an “anode” may be an anode current collector, an anode active material layer, or a combination of the two. As shown for example in FIG. 1, a coating (1) includes particles of element A which is alloyable with lithium (2) and particles of element B which is not alloyable with lithium (3) dispersed in a carbonaceous material (4). Depending on the configuration of a particular all solid state battery, coating (1) may be disposed on an anode current collector (5) as shown on in FIG. 1. In other embodiments, as shown in FIG. 2, coating (1) may be disposed on an anode active material layer (6), for example lithium metal, which in turn is disposed on the anode current collector (5).

In some embodiments, the carbonaceous material comprises at least one selected from the group consisting of carbon fiber, carbon nanotube, carbon wire, natural graphite, artificial graphite, graphene, carbon black, acetylene black, and ketjen black. In some embodiments, the carbonaceous material exhibits in a form selected from the group consisting of nanoparticles, nanoplatelets, nanowires, nanotubes, and a combination thereof. In some embodiments, the nanoparticles, nanoplatelets, nanowires and nanotubes have at least one dimension that is less than or equal to 100 nm. In some embodiments, the carbonaceous material has a volume percentage of no less than 50% in the coating.

In some embodiments, element A is chosen for its ability to form an alloy with lithium atoms or ions, thus it is alloyable with lithium. In some embodiments, element A and lithium can form an alloy wherein lithium has a weight percentage greater than or equal to 4%, 10%, 15%, 20%, 25%, or 30% in the alloy. In some embodiments, element A and lithium can form an alloy wherein lithium has a weight percentage less than or equal to 50%, 40%, 30%, 20%, or 10% in the alloy.

In some embodiments, element A is a metal or metalloid. In some embodiments, element A is at least one selected from the group consisting of Ag, Zn, Ti, Cd, Mg, Al, Ga, Si, Ge, In, Sn, Pb, Bi, Sb, and mixtures thereof. In some embodiments, element A does not comprise Ag. In some embodiments when the coating is disposed on an anode, the particles of element A may migrate or move over time within the carbonaceous material to concentrate or agglomerate to an area adjacent to the anode or even into the anode because of the lithium in the anode active material and/or the build up of lithium at the anode during charging. Too much agglomeration of particles of element A may lead to formation of lithium dendrites and a shortage of a battery cell, and thus in some embodiments, element A has a weight percentage of less than or equal to 17.5% of the coating. In some embodiments, element A has a weight percentage in a range from 1% to 17.5%, from 2.5% to 17.5%, from 5% to 17.5%, from 7.5% to 17.5%, from 1% to 15%, from 2% to 15%, from 3% to 15%, from 4% to 15%, from 5% to 15%, from 7.5% to 15%, from 1% to 12.5%, from 2% to 12.5%, from 3% to 12.5%, from 5% to 12.5%, from 7.5% to 12.5%, from 1% to 10%, from 2% to 10%, from 3% to 10%, from 5% to 10%, from 7.5% to 10%, and any and all ranges and subranges therebetween in the coating. In some embodiments, element A can be also elementary compounds that are capable of alloying with lithium, such as silicon compound and tin alloys. In some embodiments, silicon compound can be SiOₓ (where 0.5≤x≤1.5). In some embodiments, nonlimiting specific tin alloys include Cu—Sn alloys, Co—Sn alloys and the like. In some embodiments, the coating is free of agglomeration of element A and element B when viewing cross-section of the coating with an SEM.

In some embodiments, element B is chosen for its ability to not form an alloy with lithium ions or atoms, thus it is not alloyable with lithium. Without being bound by theory, it is believed that since element B is not alloyable with lithium, the particles of element B do not migrate or agglomerate within the carbonaceous material like element A. In some embodiments, element B has an electrical conductivity higher than that of the carbonaceous material and/or element A, thereby enhancing the electrical conductivity of the coating.

In some embodiments, element B is at least one selected from the group consisting of Cu, Mo, Ir, W, Co, Ni, Ru, Fe, Se, Ta, Nb, V, Zr, and mixtures thereof. In some embodiments, element B has a weight percentage in a range from 3% to 15% in the coating. In some embodiments, element B has a weight percentage in a range from 1% to 17.5%, from 2.5% to 17.5%, from 5% to 17.5%, from 7.5% to 17.5%, from 1% to 15%, from 2% to 15%, from 3% to 15%, from 4% to 15%, from 5% to 15%, from 7.5% to 15%, from 1% to 12.5%, from 2% to 12.5%, from 3% to 12.5%, from 5% to 12.5%, from 7.5% to 12.5%, from 1% to 10%, from 2% to 10%, from 3% to 10%, from 5% to 10%, from 7.5% to 10%, and any and all ranges and subranges therebetween in the coating.

In some embodiments, the electrical conductivity of element B is higher than that of element A to boost the electrical conductivity of the coating. In some embodiments, the ratio of the electrical conductivity of element B to that of element A is in a range from 1 to 30, from 2.5 to 30, from 5 to 30, from 10 to 30, from 1 to 25, from 2.5 to 25, from 5 to 25, from 10 to 25, from 1 to 20, from 2.5 to 20, from 5 to 20, from 10 to 20, from 1 to 15, from 2.5 to 15, from 5 to 15, from 10 to 15, from 1 to 10, from 2.5 to 10, from 5 to 10, and any and all ranges and subranges therebetween. In some embodiments, the ratio of the electrical conductivity of element B to that of element A is less than 1. In some embodiments, the ratio of the electrical conductivity of element B to that of element A is in a range from 0.2 to 1.0, from 0.5 to 1.0, or from 0.75 to 1.0.

In some embodiments, the weight ratio of element A to element B is in a range from 1:99 to 50:50. In some embodiments, the weight ratio of element A to element B is in a range from 1:99 to 50:50, from 2:98 to 50:50, from 3:97 to 50:50, from 4:96 to 50:50, from 5:99 to 50:50, from 7.5:92.5 to 50:50, from 10:90 to 50:50, from 15:85 to 50:50, from 20:80 to 50:50, from 1:99 to 55:45, from 2:98 to 55:45, from 3:97 to 55:45, from 4:96 to 55:45, from 5:95 to 55:45, from 7.5:92.5 to 55:45, from 10:90 to 55:45, from 15:85 to 55:45, from 20:80 to 55:45, from 1:99 to 60:40, from 2:98 to 60:40, from 3:97 to 60:40, from 4:96 to 60:40, from 5:95 to 60:40, from 7.5:92.5 to 60:40, from 10:90 to 60:40, from 15:85 to 60:40, from 20:80 to 60:40, and any and all ranges and subranges therebetween.

In some embodiments, the total weight percentage of elements A and B (element A wt %+element B wt %) in the coating is in a range from 5% to 20% in the coating. In some embodiments, the total weight percentage of elements A and B is in a range from 1% to 30%, from 1% to 25%, from 1% to 20%, from 1% to 15%, from 1% to 12.5%, from 1% to 10%, from 2.5% to 30%, from 2.5% to 20%, from 2.5% to 15%, from 2.5% to 10%, from 5% to 30%, from 5% to 25%, from 5% to 20%, from 5% to 15%, from 5% to 10%, from 7.5% to 30%, from 7.5% to 25%, from 7.5% to 20%, from 7.5% to 15%, from 7.5% to 10%, from 10% to 30%, from 10% to 25%, from 10% to 20%, from 10% to 15%, and any and all ranges and subranges therebetween.

In some embodiments, the total volume percentage of elements A and B (element A vol %+element B vol %) is in a range from 1% to 15% in the coating. In some embodiments, the total volume percentage of elements A and B in the coating is in a range from 1% to 25%, from 1% to 20%, from 1% to 15%, from 1% to 12.5%, from 1% to 10%, from 2.5% to 20%, from 2.5% to 15%, from 2.5% to 10%, from 5% to 25%, from 5% to 20%, from 5% to 15%, from 5% to 10%, from 7.5% to 25%, from 7.5% to 20%, from 7.5% to 15%, from 7.5% to 10%, from 10% to 25%, from 10% to 20%, from 10% to 15%, and any and all ranges and subranges therebetween.

In some embodiments, element A, element B, or both may be in a form of nanoparticles in the coating. In such embodiments, the nanoparticles may have an average particle size (D50) in a range from 20 nm to 80 nm. In some embodiments, the average particle size is in a range from 10 nm to 200 nm, from 10nm to 175 nm, from 10 nm to 150 nm, from 10 nm to 125 nm, from 10 nm to 100 nm, from 10 nm to 80 nm, from 10 nm to 60 nm, from 10 nm to 50 nm, from 15 nm to 200 nm, from 15 nm to 175 nm, from 15 nm to 150 nm, from 15 nm to 125 nm, from 15 nm to 100 nm, from 15 nm to 80 nm, from 15 nm to 60 nm, from 15 nm to 50 nm, from 20 nm to 200 nm, from 20nm to 175 nm, from 20 nm to 150 nm, from 20 nm to 125 nm, from 20 nm to 100 nm, from 20 nm to 80 nm, from 20 nm to 60 nm, from 20 nm to 50 nm, from 25 nm to 200 nm, from 25 nm to 175 nm, from 25 nm to 150 nm, from 25 nm to 125 nm, from 25 nm to 100 nm, from 25 nm to 80 nm, from 25 nm to 60 nm, and any and all ranges and subranges therebetween.

In some embodiments, the coating has a thickness in a range from 0.1 μm to 50 μm. In some embodiments, the coating has a thickness in a range from 0.05 μm to 100 μm, from 0.1 μm to 100 μm, from 0.25 μm to 100 μm, from 0.5 μm to 100 μm, from 1 μm to 100 μm, from 2.5 μm to 100 μm, from 5 μm to 100 μm, from 10 μm to 100 μm, from 0.05 μm to 75 μm, from 0.1 μm to 75 μm, from 0.25 μm to 75 μm, from 0.5 μm to 75 μm, from 1 μm to 75 μm, from 2.5 μm to 75 μm, from 5 μm to 75 μm, from 10 μm to 75 μm, from 0.1 μm to 50 μm, from 0.25 μm to 50 μm, from 0.5 μm to 50 μm, from 1 μm to 50 μm, from 2.5 μm to 50 μm, from 5 μm to 50 μm, from 10 μm to 50 μm, from 0.05 μm to 25 μm, from 0.1 μm to 25 μm, from 0.25 μm to 25 μm, from 0.5 μm to 25 μm, from 1 μm to 25 μm, from 2.5 μm to 25 μm, from 5 μm to 25 μm, from 10 μm to 25 μm, from 0.05 μm to 20 μm, from 0.1 μm to 20 μm, from 0.25 μm to 20 μm, from 0.5 μm to 20 μm, from 1 μm to 20 μm, from 2.5 μm to 20 μm, from 5 μm to 20 μm, from 10 μm to 20 μm, from 0.05 μm to 10 μm, from 0.1 μm to 10 μm, from 0.25 μm to 10 μm, from 0.5 μm to 10 μm, from 1 μm to 10 μm, from 2.5 μm to 10 μm, or from 5 μm to 10 μm.

In some embodiments, the coating may also include a binder. The binder may be a polymer. In some embodiments, the binder may be at least one selected from the group consisting of polyvinylidene fluoride (PVDF), polytetrafluoroethylene (PTFE), vinylidene fluoride/hexafluoropropylene copolymers, polyimide, polyethylene, polyester, polyacrylonitrile, polymethyl methacrylate, carboxymethyl cellulose/styrene-butadiene rubber (CMC/SBR) copolymers, styrene butadiene rubber (SBR) and mixtures thereof. In some embodiments, the binder has a weight percentage in a range from 1% to 20% in the coating. In some embodiments, the binder has a weight percentage in a range from 1% to 15%, from 1% to 10%, from 1% to 7.5%, from 1% to 5%, from 2% to 15%, from 2% to 10%, from 2% to 7.5%, from 2% to 5%, from 2.5% to 15%, from 2.5% to 10%, from 1.5% to 7.5%, from 2.5% to 5%, and any and all ranges and subranges therebetween in the coating.

In some embodiments, the coating may also include a dispersant. In some embodiments, the dispersant may be at least one selected from the group consisting of polyvinylpyrrolidone (PVP), ethyl cellulose, polyethylene glycol and mixtures thereof. In some embodiments, the dispersant has a weight percentage in a range from 0.01% to 5% in the coating. In some embodiments, the dispersant has a weight percentage in a range from 0.01% to 10%, from 0.01% to 7.5%, from 0.01% to 5%, from 0.01% to 2.5%, from 0.01% to 1%, from 0.01% to 0.5%, from 0.01% to 0.25%, from 0.02% to 10%, from 0.02% to 7.5%, from 0.02% to 5%, from 0.02% to 2.5%, from 0.02% to 1%, from 0.02% to 0.5%, from 0.02% to 0.25%, 0.05% to 10%, from 0.05% to 7.5%, from 0.05% to 5%, from 0.05% to 2.5%, from 0.05% to 1%, from 0.05% to 0.5%, from 0.05% to 0.25%, 0.1% to 10%, from 0.1% to 7.5%, from 0.1% to 5%, from 0.1% to 2.5%, from 0.1% to 1%, from 0.1% to 0.5%, from 0.1% to 0.25%, and any and all ranges and subranges therebetween in the coating.

The present disclosure also provides a composition for preparing the coating. The composition may include a plurality of particles of element A, a plurality of particles of element B, a carbonaceous material, and a binder. In some embodiments, the composition may also include a solvent and/or a dispersant. In some embodiments, the first and second plurality of particles of elements A and B and the carbonaceous material are dispersed in a mixture comprising the solvent, the dispersant and the binder.

In some embodiments the coating may be prepared from the composition/mixture. The method may include: (i) mixing a plurality of particles of an element A, a plurality of particles of an element B, a carbonaceous material, a binder, a solvent, and a dispersant into a mixture; (ii) coating the mixture onto a substrate, and (iii) drying the mixture coated on the substrate, thus forming a coating comprising the particles of element A and element B distributed therein. In some embodiments, the method further includes calendaring the coated substrate during or after drying the mixture coated on the substrate to ensure an even surface of the coating.

In some embodiments, the weight ratio of the solvent and the dispersant to element A, element B and binder (ratio of (solvent+dispersant):(element A+element B+binder)) in the mixture is in a range from 1:9 to 1:10.

In some embodiments, the mixture coated on the substrate is dried in air or an inert gas.

In some embodiments, the mixture coated on the substrate is dried at temperature in a range from 80° C. to 130° C. for a period from 8 hours to 48 hours.

In some embodiments, the mixture coated on the substrate is further dried under vacuum at a temperature in a range from 60° C. to 120° C. for a period in a range from 8 hours to 48 hours.

In one aspect, this disclosure provides an electrochemical device, such as an all solid state battery comprising an anode with the coating as described herein. The electrochemical device may include a cathode, a solid electrolyte, the coating, and an anode, wherein the coating may act as an interfacial layer between the solid electrolyte and the anode. In some embodiments, the anode comprises an anode current collector. In some embodiments, the anode comprises an anode active material layer comprising lithium metal and an anode current collector.

In some embodiments, the solid electrolyte comprises an oxide-based solid electrolyte, a sulfide-based solid electrolyte, or both.

In some embodiments, the oxide-based solid electrolyte is at least one selected from the group consisting of Li_{1+x+y}AlₓTi₂₋ₓSi_{y}P_{3-y}O₁₂ (0<x<2, 0≤y<3), BaTiO₃, Pb(ZrₓTi₁₋ₓ)O₃ (PZT, 0≤a≤1), Pb₁₋ₓLaₓZr_{1-y}Ti_{y}O₃ (PLZT) (0≤x<1, 0≤y<1), Pb(Mg_{1/3}Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(AlₐGa₁₋ₐ)ₓ(Ti_{b}Ge_{1-b})₂₋ₓSi_{y}P_{3-y}O₁₂ (0≤x≤1, 0≤y≤1, 0≤a≤1, and 0≤b≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M is at least one selected from the group consisting of Te, Nb, and Zr, x is an integer of 1 to 10), and Li₃₊ₓLa₃Zr₂₋ₐMₐO₁₂, wherein M is at least one selected from Ga, W, Nb, Ta, and Al, 0<a<2, x is an integer of 1 to 10.

In some embodiments, the sulfide-based solid electrolyte is at least one selected from P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive number, and Z is one selected from Ge, Zn and Ga), Li₂S—GeS₂, Li₂S—SiS₂—Li₃PO₄, Li₂S—SiS₂—LiₚMO_{q} (where p and q are each a positive number, and M is one selected from P, Si, Ge, B, Al, Ga, and In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2).

In some embodiments, the cathode comprises at least one selected from the group consisting of LiFePO₄, LiₓMO₂, LiₓNi_{1-y-z}CO_{y}M1_{z}O₂ and LiₓNi_{1-y-z}Mn_{y}M2_{z}O₂, wherein M is at least one selected from the group consisting of Ni, Co, Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M1 is at least one selected from the group consisting of Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M2 is at least one selected from the group consisting of Co, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, and wherein 0.95≤x≤1.1, 1−y−z>0, 0<y≤0.5, 0≤z≤0.5.

In some embodiments, the electrochemical device exhibits a capacity retention rate of at least 94% after 20 cycles at a discharge rate of 0.33 C.

In some embodiments, the electrochemical device exhibits a specific capacity of at least 160 mAh g⁻¹ after 20 cycles at a discharge rate of 0.33 C.

In some embodiments, the electrochemical device is a battery or a cell of a battery. In some embodiments, the electrochemical device is an all-solid-state battery.

In some embodiments, a cell comprising an anode coating as described herein may reduce the overall cell resistance by no less than 20%, no less than 25%, no less than 30%, no less than 35%, no less than 40%, no less than 45%, no less than 50%, no less than 55%, no less than 60%, or no less than 65% in comparison that that of a cell comprising Ag/C as the anode coating.

In some embodiments, a cell comprising an anode coating as described herein may reduce the charging overpotential by no less than 20%, no less than 25%, no less than 30%, no less than 35%, no less than 40%, no less than 45%, no less than 50%, no less than 55%, no less than 60%, no less than 65%, or no less than 70% at a C rate in a range from 1 C to 5.5 C in comparison to that of a cell comprising Ag/C as an anode coating or protective layer at the same C rate. In some embodiments, the C-rate is in a range from 5.5 C to 6 C, from 5.5 C to 7 C, from 5.5 C to 8 C, from 5.5 C to 9 C, or from 5.5 C to 10 C.

In some embodiments, the coating comprises Cu as element A and Zn as element B with a weight ratio of Cu to Zn of 3:7 and the weight ratio of Cu and Zn to the carbonaceous material is 5:95 and wherein the coating has a thickness of around 15-25 μm.

The disclosure will be better understood by reference to the Experimental Details which follow, but those skilled in the art will readily appreciate that the specific experiments detailed are only illustrative and are not meant to limit the disclosure as described herein, which is defined by the claims which follow thereafter.

### EXAMPLES

### Preparation of Anode With Coatings

TABLE 1
Compositions of anode coatings

| | | | A/B/carbon black |
|---|---|---|---|
| Examples | Element A | Element B | weight ratio |
| Ref. example | Ag | None | 25/0/75 |
| Comp. example 1 | Zn | None | 25/0/75 |
| Comp. example 2 | None | Cu | 0/25/75 |
| Comp. example 3 | None | None | 0/0/100 |
| Example 1 | Zn | Cu | 7.5/17.5/75 |
| Example 2 | Zn | Cu | 17.5/7.5/75 |
| Example 3 | Zn | Cu | 12.5/12.5/75 |
| Example 4 | Zn | Cu | 1.5/3.5/95 |
| Example 5 | Zn | Cu | 3/7/90 |
| Example 6 | Zn | Cu | 6/14/80 |

Nanoparticles of metal or metals with a particle size D50 of 40-60 nm and carbon black powder (D50=35 nm) were mixed at a weight ratio of 1:3 in N-methylpyrrolidone (NMP) (Sigma-Aldrich), containing 7 wt % of polyvinylidene fluoride (PVDF, Solef). N-methylpyrrolidone was slowly added to the mixture under constant stirring using a mixer (Thinky Corporation, AR-100) to prepare an anode slurry.

The slurry was then coated on a 10 μm thick SUS (stainless steel) foil using a bar-coating method and dried in the convection oven at 80° C. for 20 min. The obtained electrode was further dried under vacuum at 120° C. for 12 h. The average thickness of the coating layer was 15±2 μm. An anode with a coating comprising only carbon black was also prepared by following the same mixing procedure except there is no element A or B. Table 1 summarizes the compositions of various anode coatings.

### Battery Assembly and Test

Batteries comprising the coated anodes, an NCA cathode with at least 80% cathode active material, and an Argyrodite-type solid electrolyte as electrolyte were assembled. The battery tests were performed with 2 consecutive steps. First, the rate capability was tested at a consistent charge rate of 0.1 C during the whole test followed by a discharge rate of 0.33 C, 1 C and 0.33 C sequentially. The specific capacity results are shown in Table 2 and FIG. 3.

TABLE 2
Specific discharge capacity of batteries comprising anode coatings

| | Discharge | Discharge | Discharge |
|---|---|---|---|
| | capacity at a rate | capacity at a rate | capacity at a rate |
| Examples | of 0.33 C (1^{st}) | of 1 C | of 0.33 C (2^{nd}) |
| Ref. Ex | 186.9 | 171.4 | 198.8 |
| Comp. Ex1 | 179.5 | 132.7 | 188.1 |
| Comp. Ex 2 | 174.4 | 100.9 | 169.6 |
| Comp. Ex 3 | 189.1 | 171.2 | 201.3 |
| Ex 1 | 173.7 | 71.7 | 183.2 |
| Ex 2 | 163.3 | 70.4 | 179.4 |
| Ex 3 | 159.1 | 41.5 | 179.7 |
| Ex 4 | 184.5 | 147.3 | 189.6 |
| Ex 5 | 194.2 | 177.5 | 205.5 |
| Ex 6 | 194.5 | 172.4 | 197.5 |

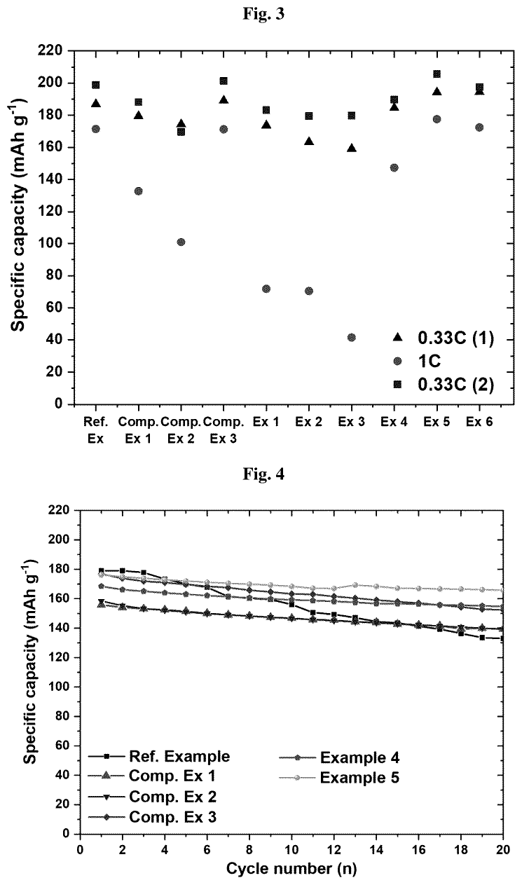

Second, the cycle performance tests were conducted under 0.33 C/0.33 C continuously at 45° C. The voltage window given to these tests was between 2.5V˜4.2V (vs. Li/Li⁺). All of the cells were operated under 4 MPa during the whole test procedure. The specific capacity results for the reference example, comparative examples 1-3 and examples 4 and 5 are shown in FIG. 4.

As shown in FIG. 3, Examples 1-3 shared the same weight percentage of the carbonaceous material and the same the total weight of elements A and B is also the same. Among examples 1-3, example 1 shows the highest specific capacity.

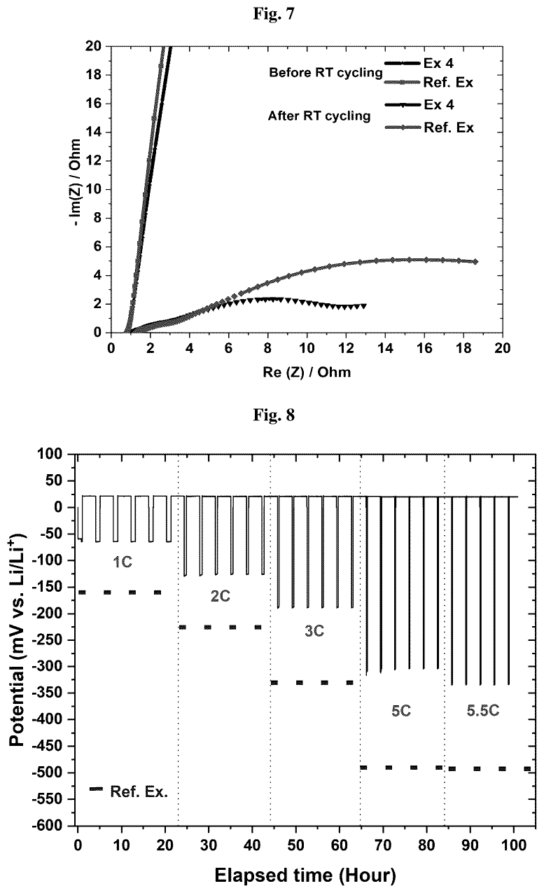

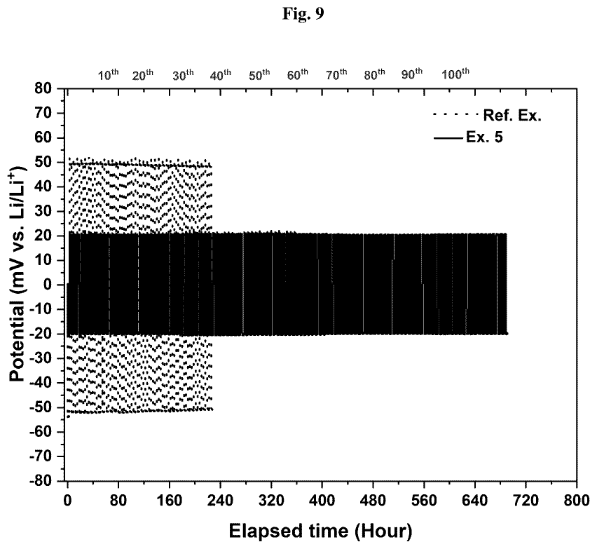

As shown in FIG. 3, Examples 4 and 5 were comparable in terms of high-rate discharge capability (1 C) to that of the reference example (Ag/C). Also, the example 5 was not only comparable to the reference example in terms of the capacity realization under 0.33 C (FIG. 4) but also the capacity retention which was well maintained up to 20 cycles. Without wishing to be bound by any theory, it can be attributed to the uniform dispersion of nanoparticles of Zn and Cu in the anode coating which are less likely to migrate towards the current collector in comparison with Ag nanoparticles. FIG. 7 is the EIS result showing that Example 4 possesses an overall cell resistance 50% lower than that of Ag/C coating. The reduced cell resistance implements easier Li migration back and forth inside the cell during cycling. In some embodiments, a cell comprising an anode coating as described herein may reduce the overall cell resistance by no less than 20%, no less than 25%, no less than 30%, no less than 35%, no less than 40%, no less than 45%, no less than 50%, no less than 55%, no less than 60%, or no less than 65% in comparison that that of a cell comprising Ag/C as anode coating.

According to FIG. 4, the cells comprising an anode coating of the reference example, comparative example 3, example 4 and example 5 exhibit a specific discharge capacity of 133, 152, 155, and 166 mAh g⁻¹, respectively, after 20 cycles with 0.33 C as both the charge and discharge rate. In some embodiments, an electrochemical device comprising an anode coating as disclosed herein exhibits a specific capacity higher than that of an electrochemical device with Ag/C nanocomposite as anode coating or carbon as anode coating. In some embodiments, an electrochemical device comprising an anode coating as disclosed herein exhibits a specific capacity which is 10%, 15%, 20%, 25%, 30%, 35%, 40%, 45%, 50% or 55% greater than that of an electrochemical device with Ag/C nanocomposite as anode coating. In some embodiments, an electrochemical device comprising an anode coating as disclosed herein exhibits a specific capacity which is 5%, 10%, 15%, 20%, 25%, 30%, 35%, or 40%, or 45% greater than that of an electrochemical device with carbon as anode coating.

As also shown in FIG. 4, the cells comprising an anode coating of the reference example, comparative example 3, example 4 and example 5 exhibit a capacity retention rate of 74%, 86%, 92% and 94%, respectively, after 20 cycles with 0.33 C as both charge and discharge rate. In some embodiments, an electrochemical device comprising an anode coating as disclosed herein exhibits a capacity retention rate higher than that of an electrochemical device comprising Ag/C nanocomposite as anode coating or carbon as anode coating. In some embodiments, an electrochemical device comprising an anode coating as disclosed herein exhibits a capacity retention rate which is 10%, 15%, 20%, 25%, 30%, 35%, 40%, 45%, 50% or 55% greater than that of an electrochemical device with Ag/C nanocomposite as anode coating. In some embodiments, an electrochemical device comprising an anode coating as disclosed herein exhibits a capacity retention rate which is 5%, 10%, 15%, 20%, 25%, 30%, 35%, or 40%, or 45% greater than that of an electrochemical device with carbon as anode coating.

Based on the data above from example 4, an electrochemical device can have a coating with Zn as element A, Cu as element B, carbon black as carbonaceous material with a weight ratio of 1.5:3.5:95 and a thickness in a range from 15 μm to 25 μm. In some embodiments, such an electrochemical device exhibits a capacity retention rate of at least 90% after 20 cycles at a charge and discharge rate of 0.33 C and/or exhibits a specific capacity of at least 155 mAh g⁻¹ after 20 cycles at a charge and discharge rate of 0.33 C.

Also based on the data above from example 5, an electrochemical device can have a coating with Zn as element A, Cu as element B, carbon black as carbonaceous material with a weight ratio of 3:7:90, and a thickness in a range from 15 μm to 25 μm. In some embodiments, such an electrochemical device exhibits a capacity retention rate of at least 90% after 20 cycles at a charge and discharge rate of 0.33 C and/or exhibits a specific capacity of at least 160 mAh g⁻¹ after 20 cycles at a discharge rate of 0.33 C.

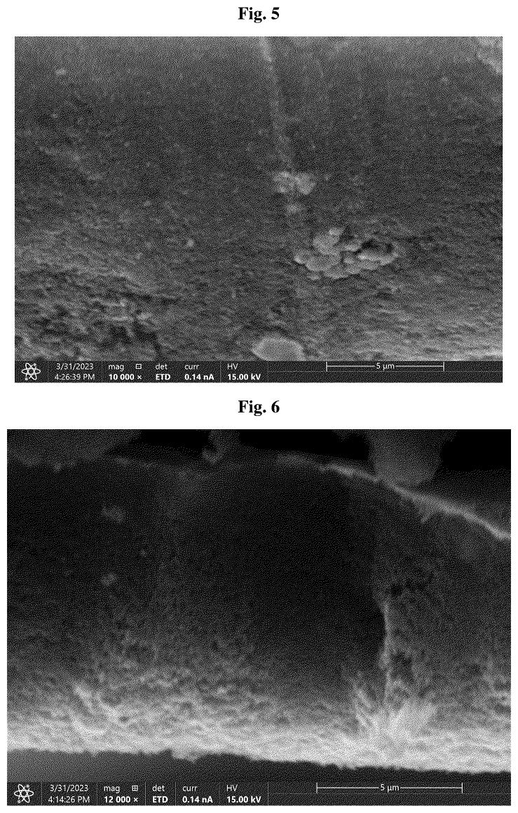

The examples also show that agglomerations of element A, which may deteriorate the electrochemical performance of a battery can be avoided in the coating. FIG. 5 is a cross-section SEM image of the coating of the reference example and shows that some of the Ag nanoparticles (element A) exist as agglomerations. In contrast, FIG. 6 is the cross-section SEM image of a coating of Example 4 comprising Zn as element A, Cu as element B and a carbonaceous material show that Zn nanoparticles and Cu nanoparticles have an average particle size in a range from 20 nm to 80 and are uniformly distributed in the carbonaceous material. There are no agglomerations.

TABLE 3
Absolute overpotentials of reference example and
example 5 in half cell rate-capability test

| | Absolute | Absolute | Percentage change in |
|---|---|---|---|
| | overpotential | overpotential | comparison to the |
| C rate* | Example 5 | Reference example | reference example |
| 1 C | around 64 mV | around 160 mV | 60% ↓ |
| 2 C | around 127 mV | around 225 mV | 46.7% ↓ |
| 3 C | around 189 mV | around 330 mV | 42.7% ↓ |
| 5 C | around 310 mV | around 490 mV | 36.7% ↓ |
| 5.5 C | around 334 mV | around 493 mV | 32.4% ↓ |

*The half cell was tested under 1, 2, 3, 5 and 5.5 C (1 C = 170 mAh) for charging (Lithium deposition on the anode side in the full cell) and 6 cycles were given with each C-rate at 45° C.

As shown in Table 3, the cell comprising the Zn/Cu anode coating according to example 5 exhibits a significantly reduced overpotential for charging. Also shown in FIG. 8, the cell comprising example 5 exhibits an overpotential of around—64 mV, around—127 mV, around—189 mV, around—310 mV and around—334 mV for C-rate of 1 C, 2 C, 3 C, 5 C and 5.5 C, respectively. However, the cell comprising the reference anode coating exhibits an overpotential of around—160 mV, around—225 mV, around—330 mV, around—490 mV and around—493 mV for C-rate of 1 C, 2 C, 3 C, 5 C and 5.5 C, respectively. In comparison to the reference example, the absolute value of the charging overpotential for example 5 is reduced by 60%, 46.7%, 42.7%, 36.7% and 32.4% for c-rate of 1 C, 2 C, 3 C, 5 C and 5.5 C, respectively.

While Ag/C reference example exhibited a frequent micro-shortage behavior which can be represented by sudden surge of charge capacity and following coulombic efficiency drop, the cell comprising the Zn/Cu anode coating exhibited very stable along with the cycling under 1/3 C. This phenomenon is potentially attributed to agglomeration and migration of Ag nanoparticles. In the case of Zn/Cu anode, since the active material content is optimized to minimize the agglomeration and the inactive material is uniformly dispersed without migration, it does not lead to the micro-shortage behavior as the reference does.

### Aspects

In a first aspect, the present disclosure provides a coating comprising:
an element A alloyable with lithium;
an element B not alloyable with lithium; and
a carbonaceous material,
wherein the carbonaceous material has a volume percentage of at least 50% in the coating.

In a second aspect according to the first aspect, element A is a metal or metalloid.

In a third aspect according to the first or second aspect, element A is capable of forming an alloy with lithium wherein the element lithium has a weight percentage greater than or equal to 4% in the alloy.

In a fourth aspect according to any preceding aspect, element A is at least one selected from the group consisting of Ag, Zn, Ti, Cd, Mg, Al, Ga, Si, Ge, In, Sn, Pb, Bi, and Sb.

In a fifth aspect according to any preceding aspect, element A has a weight percentage in a range from 1% to 10% in the coating.

In a sixth aspect according to any preceding aspect, element B has an electric conductivity greater than that of the carbonaceous material.

In a seventh aspect according to any preceding aspect, element B is at least one selected from the group consisting of Cu, Mo, Ir, W, Co, Ni, Ru, Fe, Se, Ta, Nb, V, and Zr.

In an eighth aspect according to any preceding aspect, element B has a weight percentage in a range from 3% to 15% in the coating.

In a ninth aspect according to the first aspect, the electrical conductivity of element B is greater than that of element A.

In a tenth aspect according to any preceding aspect, the weight ratio of element A to element B is in a range from 1:99 to 50:50.

In an eleventh aspect according to any preceding aspect, the total weight percentage of the element A and element B is in a range from 5% to 20% in the coating.

In a twelfth aspect according to any preceding aspect, element A, element B or both are in a form of nanoparticles, nanoplatelets, nanowires, or nanotubes in the coating.

In a thirteenth aspect according to any preceding aspect, the nanoparticles have an average particle size (D50) in a range from 20 nm to 80 nm.

In a fourteenth aspect according to the thirteenth aspect, the nanoparticles are free of agglomeration in a cross-section of the coating.

In a fifteenth aspect according to any preceding aspect, the coating has a thickness in a range from 0.1 μm to 50 μm.

In a sixteenth aspect according to any preceding aspect, the coating further comprises a binder.

In a seventeenth aspect according to any preceding aspect, the coating further comprises a dispersant.

In an eighteenth aspect, the present disclosure provides a composition for preparing the coating according to the first aspect. The composition comprises:
a first plurality of particles of element A,
a second plurality of particles of element B,
a carbonaceous material, and
a binder.

In a nineteenth aspect according to the eighteenth aspect, the composition further comprises a solvent.

In a twentieth aspect according to the eighteenth or nineteenth aspect, the composition further comprises a dispersant.

In a twenty-first aspect according to the nineteenth aspect, the solvent is selected from the group consisting of N-methylpyrrolidone (NMP), tetrahydrofuran (THF), ethanol, distilled water, and mixtures thereof.

In a twenty-second aspect according to the twentieth aspect, the dispersant is at least one selected from the group consisting of polyvinylpyrrolidone (PVP), ethyl cellulose, polyethylene glycol and mixtures thereof, and wherein the dispersant has a weight percentage in a range from 0.01% to 5% in the composition.

In a twenty-third aspect according to any of the eighteenth through twenty-second aspects, the binder is at least one selected from the group consisting of polyvinylidene fluoride (PVDF), polytetrafluoroethylene (PTFE), vinylidene fluoride/hexafluoropropylene copolymers, polyimide, polyethylene, polyester, polyacrylonitrile, polymethyl methacrylate, carboxymethyl cellulose/styrene-butadiene rubber (CMC/SBR) copolymers, styrene butadiene rubber (SBR) and mixtures thereof, and wherein the binder has a weight percentage in a range from 1% to 20% in the composition.

In a twenty-fourth aspect according to any of the eighteenth through twenty-third aspects, the carbonaceous material is at least one selected from the group consisting of carbon fiber, carbon nanotube, carbon wire, natural graphite, artificial graphite, graphene, carbon black, acetylene black, ketjen black, and mixtures thereof.

In a twenty-fifth aspect, the present disclosure provides a method for preparing a coating, comprising:
a) mixing a plurality of particles of an element A, a plurality of particles of element B, a carbonaceous material, a binder, a solvent, and a dispersant into a mixture,
b) coating the mixture onto a substrate, and
c) drying the mixture coated on the substrate, thus forming a coating comprising the particles of the element A and the element B distributed therein,
wherein element A is alloyable with lithium and element B is not alloyable with lithium.

In a twenty-sixth aspect according to the twenty-fifth aspect, the method further comprises: calendaring the coated substrate during or after drying the mixture coated on the substrate.

In a twenty-seventh aspect according to the twenty-fifth or twenty-sixth aspect, the weight ratio of the solvent and the dispersant to the element A, the element B and the binder is in a range from 1:9 to 1:10.

In a twenty-eighth aspect according to any of the twenty-fifth through twenty-seventh aspects the mixture coated on the substrate is dried in an inert gas.

In a twenty-ninth aspect, the present disclosure provides an electrochemical device comprising the coating according to any of the first through seventeenth aspects disposed on a negative electrode.

In a thirtieth aspect according to the twenty-ninth aspect, the negative electrode comprises an anode current collector.

In a thirty-first aspect according to the twenty-ninth or thirtieth aspect, the negative electrode comprises a layer of an anode active material comprising lithium metal.

In a thirty-second aspect according to any of the twenty-ninth through thirty-first aspects, the electrochemical device further comprises a solid electrolyte.

In a thirty-third aspect according to the thirty-second aspect, the solid electrolyte comprises an oxide-based solid electrolyte, a sulfide-based solid electrolyte, or both.

In a thirty-fourth aspect according to the thirty-third aspect, the oxide-based solid electrolyte is at least one selected from the group consisting of Li_{1+x+y}AlₓTi₂₋ₓSi_{y}P_{3-y}O₁₂ (0<x<2, 0≤y<3), BaTiO₃, Pb(ZrₓTi₁₋ₓ)O₃ (PZT, 0≤a≤1), Pb₁₋ₓLaₓZr_{1-y}Ti_{y}O₃ (PLZT) (0≤x<1, 0≤y<1), Pb(Mg_{1/3}Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(AlₐGa₁₋ₐ)ₓ(Ti_{b}Ge_{1-b})₂₋ₓSi_{y}P_{3-y}O₁₂ (0≤x≤1, 0≤y≤1, 0≤a≤1, and 0≤b≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M is at least one selected from the group consisting of Te, Nb, and Zr, x is an integer of 1 to 10), Li₃₊ₓLa₃Zr₂₋ₐMₐO₁₂, wherein M is at least one selected from Ga, W, Nb, Ta, and Al, 0<a<2, x is an integer of 1 to 10, and mixtures thereof.

In a thirty-fifth aspect according to the thirty-third aspect, wherein the sulfide-based solid electrolyte is at least one selected from P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive number, and Z is one selected from Ge, Zn and Ga), Li₂S—GeS₂, Li₂S—SiS₂—Li₃PO₄, Li₂S—SiS₂—LiₚMO_{q} (where p and q are each a positive number, and M is one selected from P, Si, Ge, B, Al, Ga, and In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), and mixtures thereof.

In a thirty-sixth aspect according to any of the twenty-ninth through thirty-fifth aspects, the electrochemical device further comprises a cathode.

In a thirty-seventh aspect according to the thirty-sixth aspect, the cathode comprises at least one selected from the group consisting of LiFePO₄, LiₓMO₂, LiₓNi_{1-y-z}Co_{y}M1_{z}O₂ and LiₓNi_{1-y-z}Mn_{y}M2_{z}O₂, wherein M is at least one selected from the group consisting of Ni, Co, Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M1 is at least one selected from the group consisting of Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M2 is at least one selected from the group consisting of Co, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, and wherein 0.95≤x≤1.1, 1−y−z>0, 0<y≤0.5, 0≤z≤0.5.

In a thirty-eighth aspect according to any of the twenty-ninth through the thirty-seventh aspects, the electrochemical device exhibits a capacity retention rate of at least 90% after 20 cycles at a discharge rate of 0.33 C.

In a thirty-ninth aspect according to any of the twenty-ninth through thirty-eighth aspects, the electrochemical device exhibits a specific capacity of at least 155 mAh g⁻¹ after 20 cycles at a discharge rate of 0.33 C.

In a fortieth aspect according to any of the twenty-ninth through thirty-ninth aspects, the electrochemical device exhibits at a C-rate in a range from 1 C to 5.5 C a charging overpotential of at least 30% lower than that of an electrochemical device comprising an anode coating comprising Ag/C layer at the same C-rate.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

We claim:

1. A coating, comprising:
an element A alloyable with lithium;
an element B not alloyable with lithium; and
a carbonaceous material,
wherein the carbonaceous material has a volume percentage of at least 50% in the coating, and the element A is a metal or metalloid.

2. The coating of claim 1, wherein the element A is capable of forming an alloy with lithium and wherein the element lithium has a weight percentage greater than or equal to 4% in the alloy.

3. The coating of claim 1, wherein the element A is at least one selected from the group consisting of Ag, Zn, Ti, Cd, Mg, Al, Ga, Si, Ge, In, Sn, Pb, Bi, and Sb.

4. The coating of claim 1, wherein the element B has an electric conductivity greater than that of the carbonaceous material and is at least one selected from the group consisting of Cu, Mo, Ir, W, Co, Ni, Ru, Fe, Se, Ta, Nb, V, and Zr.

5. The coating of claim 1, wherein the element A has a weight percentage in a range from 1% to 10% in the coating and the element B has a weight percentage in a range from 3% to 15% in the coating.

6. The coating of claim 1, wherein the total weight percentage of the element A and element B is in a range from 5% to 20% in the coating.

7. The coating of claim 1, wherein the electrical conductivity of the element B is greater than that of element A.

8. The coating of claim 1, wherein the weight ratio of the element A to the element B is in a range from 1:99 to 50:50.

9. The coating of claim 1, wherein the element A, the element B or both are in a form of nanoparticles, nanoplatelets, nanowires, or nanotubes in the coating.

10. The coating of claim 9, wherein the nanoparticles are free of agglomeration in a cross-section of the coating and the nanoparticles have an average particle size (D50) in a range from 20 nm to 80 nm.

11. The coating of claim 1, wherein the coating has a thickness in a range from 0.1 μm to 50 μm.

12. A method for preparing a coating, comprising:
a) mixing a plurality of particles of an element A, a plurality of particles of element B, a carbonaceous material, a binder, a solvent, and a dispersant into a mixture,
b) coating the mixture onto a substrate,
c) calendaring the coated substrate during or after drying the mixture coated on the substrate, and
d) drying the mixture coated on the substrate, thus forming a coating comprising the particles of the element A and the element B distributed therein,
wherein element A is alloyable with lithium and element B is not alloyable with lithium, and wherein the element A is a metal or metalloid.

13. The method of claim 12, wherein the dispersant comprises at least one selected from the group consisting of polyvinylpyrrolidone (PVP), ethyl cellulose, polyethylene glycol and mixtures thereof, and wherein the dispersant has a weight percentage in a range from 0.01% to 5% in the mixture.

14. The method of claim 12, wherein the weight ratio of the solvent and the dispersant to the element A, the element B and the binder is in a range from 1:9 to 1:10.

15. An electrochemical device comprising the coating of claim 1 disposed on a negative electrode.

16. The electrochemical device of claim 15, wherein the negative electrode comprises a layer of an anode active material comprising lithium metal.

17. The electrochemical device of claim 15, further comprising a sulfide-based solid electrolyte comprising at least one selected from the group consisting of P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive number, and Z is one selected from Ge, Zn and Ga), Li₂S—GeS₂, Li₂S—SiS₂—Li₃PO₄, Li₂S—SiS₂—LiₚMO_{q} (where p and q are each a positive number, and M is one selected from P, Si, Ge, B, Al, Ga, and In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), and mixtures thereof.

18. The electrochemical device of claim 15, wherein the electrochemical device exhibits a capacity retention rate of at least 90% after 20 cycles at a discharge rate of 0.33 C.

19. The electrochemical device of claim 15, wherein the electrochemical device exhibits a specific capacity of at least 155 mAh g⁻¹ after 20 cycles at a discharge rate of 0.33 C.

20. The electrochemical device of claim 15, wherein the electrochemical device exhibits at a C-rate in a range from 1 C to 5.5 C a charging overpotential of at least 30% lower than that of an electrochemical device comprising an anode coating comprising Ag/C layer at the same C-rate.
